(19) United States
(12) Patent Application Publication
(10) Pub. No.: US 2017/0129560 A1
(43) Pub. Date: May 11, 2017

(54) METHOD FOR ASSEMBLING AN INSTRUMENT PANEL TO A VEHICLE CHASSIS AS WELL AS DEVICE AND CENTERING BOLT USED THEREBY

(71) Applicant: GM GLOBAL TECHNOLOGY OPERATIONS LLC, Detroit, MI (US)

(72) Inventor: Michael-Albert RATTLER, Ruesselsheim (DE)

(73) Assignee: GM GLOBAL TECHNOLOGY OPERATIONS LLC, Detroit, MI (US)

(21) Appl. No.: 15/234,151

(22) Filed: Aug. 11, 2016

(30) Foreign Application Priority Data
Aug. 12, 2015 (DE) 102015010578.7

(51) Int. Cl. B62D 65/14

(52) U.S. Cl. CPC B62D 65/14

(57) ABSTRACT

A method for assembling an instrument panel to a vehicle chassis is disclosed, as well as a device and a centering bolt used therefor. In particular, a y-z-centering bolt and a z-centering bolt are aligned relative to the individual vehicle center by a device for use as a y-z-positioning gauge and a device for use as a z-positioning gauge and connected with struts. The struts are connected to the vehicle chassis. The fixture device of an instrument panel is aligned and connected with the strut by the y-z-centering bolt and the z-centering bolt. Subsequently, the instrument panel is connected with the fixture device.

### CROSS-REFERENCE TO RELATED APPLICATION

This application claims priority to German Patent Application No. DE102015010578.7, filed Aug. 12, 2015, which is incorporated herein by reference in its entirety.

### TECHNICAL FIELD

The present disclosure relates to a method for assembling an instrument panel to a vehicle chassis, and more particularly to a device and a centering bolt used thereby.

### BACKGROUND

As to ensure a high-quality impression of a vehicle interior, in particular of a passenger car, it is of substantial significance that installation and trim components are positional aligned accurate relative to the vehicle chassis as well as relative to each other. Due to fabrication tolerances of the vehicle chassis it happens that the position of mounting parts to the vehicle chassis as well as the position of mounting parts to each other are individual for any vehicle.

In case such individual fabrication tolerances are not taken into account, these fabrication tolerances affect the interior trim (or interior lining) and arise at the transition from the door panel (door trim) to the instrument panel, in particular. For example, optical guides that are located at the door panel as well as at the instrument panel do not lie in the same plane due to the fabrication tolerance and the impression of the vehicle interior is thereby diminished. Furthermore, the gap width between the instrument panel and the interior trim of the respective front door may be distinct differently due to the fabrication tolerance. Such deviation in the gap widths negatively impacts the optical overall impression of the vehicle interior.

As to ensure a high-quality optical impression of the vehicle interior in the region of the instrument panel it is, thus, necessary to align the instrument panel for each vehicle relative to the individual vehicle center and the individual left and right front doors.

DE 10 2009 024 084 A1 discloses an adjusting device as well as a method which enable adjusting of a vehicle component to be mounted relative to a vehicle chassis. The connection of the vehicle component with the vehicle chassis is made with a mounting bracket. A leg of the mounting bracket is connected with the vehicle chassis and the other leg carries a compensation element. The compensation element and the second leg are arranged movable relative to each other. The vehicle component to be mounted can be aligned relative to the vehicle chassis by the compensation element. The compensation element is fixed to the other leg in the adjusted position after alignment.

It is possible to align a vehicle component to be mounted relative to a vehicle chassis by the method described in the document mentioned before and using the device described in the document mentioned before. For this purpose, it is necessary to produce an adjusting device for each vehicle component to be mounted, wherein this adjusting device includes multiple separate components.

### SUMMARY

The present disclosure addresses the problem of providing an improved embodiment for a method of the kind mentioned at the beginning. The method provides that the relative position of the instrument panel to a left front door and to a right front door can be optimized relatively simple and, in particular, no individual compensation elements must be produced and mounted. The present disclosure is based on the idea to align the instrument panel in transverse direction of the vehicle, also referred to as y-direction, and in vertical direction of the vehicle, also referred to as z-direction, relative to the left front door and to the right front door. Alignment of the instrument panel in y-direction thereby takes place relative to a vehicle center. The vehicle center is defined in that the distance between the vehicle center and the left front door equals the distance between the vehicle center and the right front door. The position of the instrument panel in longitudinal direction of the vehicle, also referred to as x-axis, is defined by struts interconnected with the vehicle chassis. Alignment of the instrument panel in y-direction and in z-direction takes place by a y-z-positioning gauge and a z-positioning gauge.

In accordance with a method for assembling the instrument panel to the vehicle chassis a strut is connected to a vehicle chassis in the region of a left side wall and a right side wall of a front end of the vehicle, respectively. These struts can be connected to a fixture device of the instrument panel and define a measure for the position of the instrument panel in x-direction. A left and a right front door are connected with the vehicle chassis. The distance of the left front door and the right front door in y-direction is individual for each vehicle and depends on the individual fabrication tolerances of the vehicle chassis and the mounting parts of the respective vehicle. An individual vehicle center is measured first as to align the instrument panel in y-direction positional accurate. The vehicle center is defined in that the distance between the vehicle center and the left front door equals the distance between the vehicle center and the right front door. Subsequently, the distance of the left and right front door from the vehicle center in y-direction is measured.

In a preferred embodiment of the method provides that the measuring of the individual vehicle center as well as the distances of the front doors of the vehicle from the vehicle center is carried out by a laser measurement system. Such a measurement system enables a very precise distance measurement and can be integrated easily in the fabrication process of vehicles.

On the basis of the measured distance of the left and right front door from the vehicle center, a y-z-positioning gauge is adjusted such that in the assembled state the desired distance between the left front door and the instrument panel as well as right front door and instrument panel is achieved.

Thereby and as especially preferable it is provided that a code value is generated from the measured distance of the left and right front door to the vehicle center and this code value correlates with an adjustment graduation of the y-z-positioning gauge. The advantage of this is that the individual adjustment of the y-z-positioning gauge is facilitated.

Subsequently, the individually adjusted y-z-positioning gauge is connected to one of the front doors. A measure for the position of the instrument panel in y-direction and in z-direction is thereby defined.

Following, a y-z-centering bolt is aligned by the y-z-positioning gauge and subsequently connected to the strut assigned to that front door. The y-z-centering bolt defines the measure for the alignment of the instrument panel in y-direction and z-direction.

A z-positioning gauge is connected with the other front door, which z-positioning gauge defines a measure for the position of the instrument panel in z-direction. A z-centering bolt is aligned by the z-positioning gauge and subsequently, and the z-centering bolt is connected with the strut assigned to the other front door.

By interconnecting the y-z-positioning gauge and the z-positioning gauge with the respective front door, the individual position of the front doors in z-direction is applied to the y-z-centering bolt and the z-centering bolt. Thereby it is ensured that in the assembled state the instrument panel has the desired position in z-direction relative to the respective front door.

Subsequently, the y-z-positioning gauge and the z-positioning gauge are disconnected from the respective front door. The fixture device of the instrument panel includes a y-z-mounting eyelet and a z-mounting eyelet. Hereby, the y-z-mounting eyelet corresponds to the y-z-centering bolt and the z-mounting eyelet corresponds to the z-centering bolt. Alignment of the fixture device in y-direction takes place by the y-z-centering bolt and alignment in z-direction takes place by the y-z-centering bolt and the z-centering bolt.

As the alignment in y-direction takes place by the y-z-centering bolt and not by means of the z-centering bolt, it is guaranteed that individual distances between left front door and right front door do not affect negatively the assembly of the fixture device of the instrument panel. In case the z-centering bolt likewise defines a measure for the y-alignment of the fixture device of the instrument panel, assembly of the fixture device of the instrument panel would not or only under tension of the fixture device be possible at a distance of the y-z-centering bolt and the z-centering bolt in y-direction which deviates from the distance of the y-z-mounting eyelet and the z-mounting eyelet of the fixture device of the instrument panel.

After alignment of the fixture device of the instrument panel, the same is connected with the struts. Subsequently, the instrument panel is connected with the aligned and assembled fixture device.

The method according to the present disclosure and its improvements ensure that in the assembled state the alignment of the instrument panel is individually adapted to the vehicle. As the individual alignment of the instrument panel takes place based on the left and right front door as well as the individual vehicle center, an optimum fit between the door panel and the instrument panel is guaranteed.

A further advantage of the method according to the present disclosure is that the alignment and the interconnection of the y-z-centering bolt and the z-centering bolt can be carried out on a body in white (body shell). Thus, after alignment and connection of the y-z-centering bolt and the z-centering bolt with the respectively assigned strut took place, the front doors and the body in white can be further assembled separate from each other in the fabrication process. The possibly different assembling stations for assembling the door panel and for assembling the instrument panel may be located spatially far off each other. At the final assembly of the front door with door panel to the vehicle chassis with assembled instrument panel, the door panel and instrument panel are aligned optimally relative to each other.

The present disclosure further proposes a special device and a special centering bolt for use with the method. Thereby, the device serves for usage as y-z-positioning gauge or as z-positioning gauge. In particular, the y-z-positioning gauge is angled (bent) and includes two legs. The first leg can be reversibly connected with one of the front doors. The second leg includes a y-z-positioning eyelet which corresponds to the y-z-centering bolt. The y-z-positioning eyelet is formed such that it interacts positively locked with the y-z-centering bolt. The device further includes an adjustor which enables adjustment of the relative position between the y-z-positioning eyelet and one of the front doors in y-direction. Preferably, the z-positioning gauge is angled and includes two legs. The first leg can be reversibly connected with the other front door and the second leg includes a z-positioning eyelet corresponding to the z-centering bolt. The z-positioning eyelet is formed such that it interacts positively locked with the z-centering bolt.

In connection with the method according to the present disclosure, a centering bolt can be used as y-z-centering bolt or as z-centering bolt. In particular, the y-z-centering bolt is cone-shaped and the corresponding y-z-mounting eyelet of the fixture device is circular-shaped. The y-z-mounting eyelet and the y-z-centering bolt interact positively locked in y-direction and in z-direction after alignment of the fixture device. The z-centering bolt is preferably formed as a flat plate which is tapered on the far side of the strut, and the corresponding z-mounting eyelet of the fixture device is rectangular-shaped. The z-mounting eyelet and the z-centering bolt interact positively locked in z-direction after alignment of the fixture device.

### BRIEF DESCRIPTION OF THE DRAWINGS

The present disclosure will hereinafter be described in conjunction with the following drawing figures, wherein like numerals denote like elements.

FIG. 1 shows a vehicle chassis in the region of a front end of the vehicle;

FIG. 2 shows a left strut and a y-z-centering bolt connected with this strut by a screw connection as well as a corresponding fixture device in a sectional view;

FIG. 3 shows the left strut and the y-z-centering bolt connected with this strut in a top view;

FIG. 4 shows the fixture device in a top view, wherein the fixture device includes an y-z-mounting eyelet;

FIG. 5 shows a right strut and a z-centering bolt connected with this strut by a screw connection as well as a corresponding fixture device in a sectional view;

FIG. 6 shows the right strut and the z-centering bolt connected with this strut in a top view;

FIG. 7 shows the fixture device in a top view, wherein the fixture device includes a z-mounting eyelet;

FIG. 8 shows, in a view in y-direction, an x-y-positioning gauge connected with a left side door;

FIG. 9 shows, in a view in x-direction, an x-y-positioning gauge connected with a left side door; and

FIG. 10 shows, in a view in z-direction, an x-y-positioning gauge connected with a left side door.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

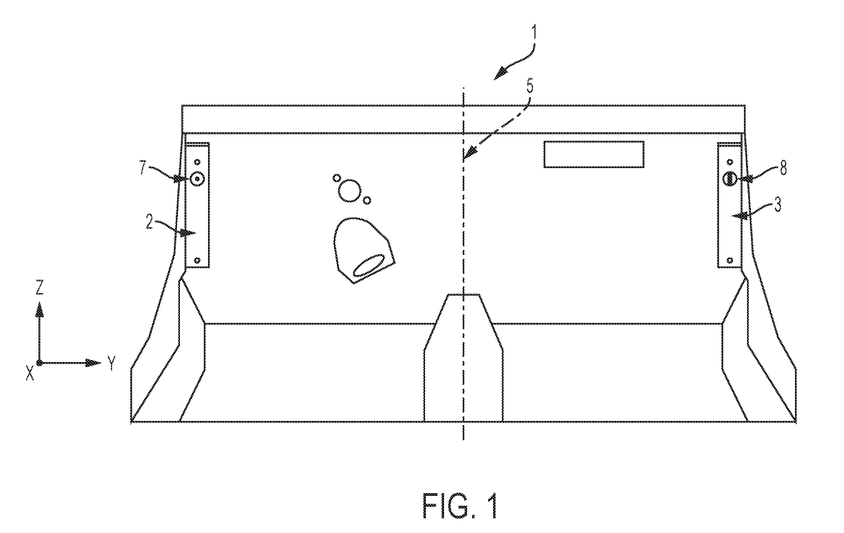

When assembling a vehicle chassis, a left side wall and a right side wall are connected with a floor assembly and a front wall of the vehicle chassis. In FIG. 1, a view of the vehicle chassis 1 in the region of the front end of the vehicle is shown, wherein in FIG. 1 the viewing direction points in longitudinal direction of the vehicle, also referred to as x-direction or x-axis. Correspondingly, the y-direction or the y-axis is oriented in transverse direction of the vehicle and the z-axis or z-direction points in the vertical direction of the vehicle. In the front end of the vehicle shown in FIG. 1, the driver's area is located on the left side while the front passenger's area is located on the right side. In the region of the left side wall of the vehicle chassis 1 a left strut 2 is connected with the vehicle chassis 1 and in the region of the right side wall of the vehicle chassis 1 a right strut 3 is connected with the vehicle chassis 1. When assembling the instrument panel, a fixture device 4 of the instrument panel is connected with the respective strut 2, 3. A measure for the position of the instrument panel in x-direction is defined by the position of the struts 2, 3.

Due to fabrication tolerances of the vehicle chassis 1, each vehicle has an individual vehicle center 5. The vehicle center 5 is defined in y-direction in that the distance between the vehicle center 5 and a left front door 6 equals the distance between the vehicle center 5 and the right front door. Correspondingly, the distance between the left strut 2 and the vehicle center 5 and the distance between the right strut 3 and the vehicle center 5 is individual for each vehicle.

As to achieve an optimal alignment of the instrument panel's position, a y-z-centering bolt 7 and a z-centering bolt 8 are aligned individually with respect to the vehicle center 5 as well as to the assembled front doors.

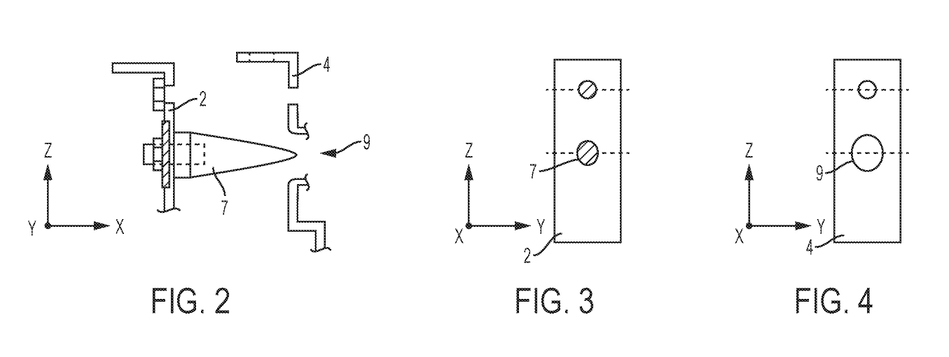

FIG. 2 shows, in a sectional view, the y-z-centering bolt 7, as well as the fixture device 4 of the instrument panel corresponding thereto prior to assembling the fixture device 4. The y-z-centering bolt 7 is cone-shaped and connected with the strut 2 by a screw connection. The fixture device 4 includes a y-z-mounting eyelet 9. This is circular shaped and interacts positively locked with the cone-shaped y-z-centering bolt 7 after alignment of the fixture device 4. The circular shaping of the y-z-mounting eyelet 9 is shown in FIG. 4 in the top view onto the fixture device 4. The circular shaped cross section of the y-z-centering bolt 7 is shown in FIG. 3 in a top view onto the strut 2 with connected y-z-centering bolt 7.

The conical shape of the y-z-centering bolt 7 has the advantage that for purpose of alignment of the fixture device 4 of the instrument panel it is sufficient to insert the tip of the cone-shaped y-z-centering bolt 7 into the circular shaped y-z-mounting eyelet 9 of the fixture device 4. When displacing the fixture device 4 in direction of the strut 2, the conical y-z-centering bolt 7 and the circular shaped y-z-mounting eyelet 9 interact with each other such that the fixture device 4 aligns independently in y-direction and in z-direction.

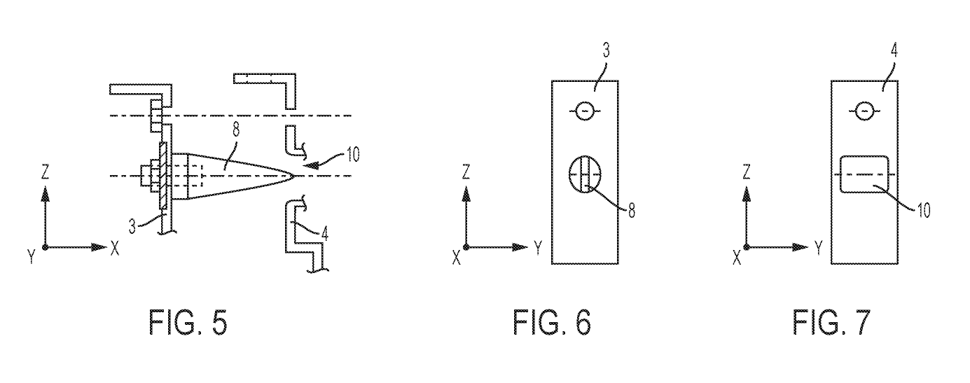

FIG. 5 shows, in a sectional view, the z-centering bolt 8, as well as the fixture device 4 of the instrument panel corresponding thereto prior to assembling the fixture device 4. The z-centering bolt 8 is formed substantially as a flat plate which is tapered on the far side relative to the strut 3. The z-centering bolt 8 is connected with the strut 3 by a screw connection. The corresponding z-mounting eyelet 10 of the fixture device 4 is substantially rectangular shaped. The rectangular shaping of the y-z-mounting eyelet 10 is shown in FIG. 7 in a top view onto the fixture device 4. The rectangular cross section of the plate of the z-centering bolt 8 is shown in FIG. 6 in the top view onto the strut 2 with connected z-centering bolt 8.

This embodiment facilitates alignment of the fixture device 4 to the effect that it is sufficient to insert the tip of the z-centering bolt 8 into the z-mounting eyelet 10. When displacing the fixture device 4 towards the strut 3, the z-centering bolt 8 and the z-mounting eyelet 10 interact such that the fixture device 4 aligns independently in z-direction.

The z-centering bolt 8 can be moved in y-direction within the z-mounting eyelet 10 so that the z-centering bolt 8 and the z-mounting eyelet 10 do not define a measure for the position of the fixture device of the instrument panel in y-direction and the measure which is defined by the y-z-centering bolt 7 is adopted for the position of the instrument panel in y-direction.

According to the method of the present disclosure and its improvements, alignment of the y-z-centering bolt 7 takes place by a y-z-positioning gauge 11 and the alignment of the z-centering bolt 8 takes place by a z-positioning gauge. For this purpose, the left front door 6 and the right front door are connected with the vehicle chassis 1 first. The y-z-positioning gauge 11 is adjusted in y-direction depending on the distance of the left front door 6 and the right front door from the vehicle center 5 and is subsequently connected with one of the front doors.

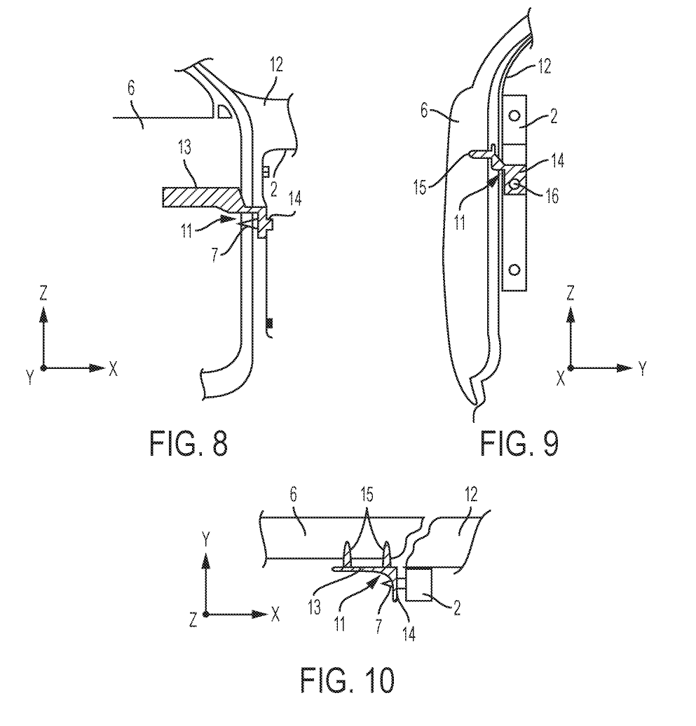

FIG. 8, FIG. 9 and FIG. 10 show views of the y-z-positioning gauge 11 in x-direction, y-direction, and z-direction. The y-z-positioning gauge 11 is connected with the left front door 6. Here, the left front door 6 is connected with a left A-pillar 12 of the vehicle chassis 1 and the right front door correspondingly connected with the right A-pillar assigned thereto.

The y-z-positioning gauge 11 is preferably angled. The y-z-positioning gauge 11 includes two legs 13, 14. A first leg 12 is reversibly connected with one of the front doors 6. The connection with the front door 6 takes place by a front door centering bolt 15 connected with the first leg 12, as shown by FIG. 9 and FIG. 10. The second leg 14 includes a y-z-positioning eyelet 16. The y-z-positioning eyelet 16 interacts positively locked with the y-z-centering bolt 7. FIG. 8 and FIG. 9 show the y-z-positioning gauge 11 after inserting the y-z-centering bolt 7 into the y-z-positioning eyelet 16. FIG. 10 shows the y-z-positioning gauge 11 in a top view onto the y-z-positioning eyelet 16 prior to inserting the y-z-centering bolt 7 into the y-z-positioning eyelet 16.

The second leg 14 is formed such that the y-z-positioning eyelet 16 is parallel to the surface of the strut 2 when the y-z-positioning gauge 11 is connected with the front door.

Due to the connection of the y-z-positioning gauge 11 with the front door 6, the individual position of the front door 6 in z-direction is applied to the y-z-positioning gauge 11. The relative position between the y-z-positioning eyelet 16 and the connected front door 6 is adjustable in y-direction by an adjusting means. The adjusting means enables alignment of the y-z-positioning eyelet 16 to the individual vehicle center 5 in y-direction. The individual y-alignment and z-alignment are applied to the y-z-centering bolt 7 by the y-z-positioning eyelet 16. To this purpose, the y-z-centering bolt 7 is inserted into the y-z-positioning eyelet 16. The y-z-positioning eyelet 16 and the y-z-centering bolt 7 interact positively locked. Subsequently, the y-z-centering bolt 7 is connected with the strut 2 assigned to the corresponding front door 6.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-12. (canceled)

13. A method for assembling an instrument panel to a vehicle chassis, wherein the instrument panel is configured to be aligned relative to an individual vehicle center, with the following features, which are related to the x-axis/x-direction in longitudinal direction of the vehicle, a y-axis/y-direction in transverse direction of the vehicle, and a z-axis/z-direction in vertical direction of the vehicle, the method comprising:
a. connecting a strut, respectively, with the vehicle chassis in a region of the respective side wall of a front end of the vehicle chassis, wherein the struts define a measure for the position of the instrument panel in the x-direction;
b. connecting a left front door and a right front door with the vehicle chassis;
c. measuring the individual vehicle center in the y-direction, wherein the vehicle center is defined in the y-direction in that the distance between the vehicle center and a left front door equals the distance between the vehicle center and the right front door;
d. determining the distance in the y-direction of the left and right front door from the vehicle center;
e. adjusting a y-z-positioning gauge depending on the distance in the y-direction of the left and the right front door from the vehicle center;
f. connecting the y-z-positioning gauge with one of the front doors, wherein the y-z-positioning gauge defines a measure for the position of the instrument panel in the y-direction and in the z-direction,
g. aligning a y-z-centering bolt by the y-z-positioning gauge;
h. connecting the y-z-centering bolt with the strut assigned to this front door;
i. connecting a z-positioning gauge with the other front door, wherein the z-positioning gauge defines a measure for the position of the instrument panel in z-direction;
j. aligning a z-centering bolt by a z-positioning gauge;
k. connecting the z-centering bolt with the strut assigned to the other front door;
l. disconnecting the y-z-positioning gauge from the one front door;
m. disconnecting the z-positioning gauge from the other front door;
n. aligning a fixture device of the instrument panel, wherein the fixture device include a y-z-mounting eyelet and a z-mounting eyelet, and the alignment of the fixture device in the y-direction takes place by the y-z-mounting eyelet corresponding to the y-z-centering bolt and the alignment in the z-direction takes place by the y-z-mounting eyelet corresponding to the y-z-centering bolt and the z-mounting eyelet corresponding to the z-centering bolt;
o. connecting the fixture device of the instrument panel with the struts; and
p. connecting the instrument panel with the fixture device.

14. The method according to claim 13, executed in sequential order from a.-p.

15. The method according to claim 13, further comprising measuring the individual vehicle center in transverse direction of the vehicle takes place by a laser measuring system.

16. The method according to claim 13, further comprising generating a code value from the value of the distance of the left front door and the right front door from the vehicle center in the y-direction.

17. The method according to claim 16, further comprising correlating the code value to an adjustment graduation of the y-z-positioning gauge.

18. The method according to claim 13, wherein the method is carried out on a body in white.

19. A device for used as y-z-positioning gauge in the method according to claim 13, wherein the y-z-positioning gauge is angled and comprises a first leg reversibly connected to one of the front doors and a second leg having a y-z-positioning eyelet corresponding to the y-z-centering bolt, wherein the y-z-positioning eyelet is formed such that the y-z-positioning eyelet interacts positively locked with the y-z-centering bolt, and wherein the device further includes an adjustor configured to adjust the relative position between the y-z-positioning eyelet and one of the front doors in the y-direction.

20. The device according to claim 19, wherein the adjustor has predefined adjustment graduation.

21. The device according to claim 19 for use as a z-positioning gauge, wherein the z-positioning gauge is angled and comprises a first leg can be reversibly connected with the other front door and a second leg having a z-positioning eyelet corresponding to the z-centering bolt, wherein the z-positioning eyelet is formed such that the z-positioning eyelet interacts positively locked with the z-centering bolt.

22. The device according to claim 19, wherein the first leg is connectable with a front door centering bolt which can be inserted into a mounting eyelet of a front door.

23. A centering bolt for use as y-z-centering bolt with the method according to claim 13, wherein the y-z-centering bolt comprises a cone-shaped member and the corresponding y-z-mounting eyelet of the fixture device is circular shaped member, wherein the y-z-mounting eyelet and the y-z-centering bolt interact positively locked in the y-direction and in z-direction after alignment of the fixture device.

24. The centering bolt for use as z-centering bolt with a method according to claim 13, wherein the z-centering bolt is formed as a flat plate which is tapered on a far side relative to the strut and the corresponding z-mounting eyelet of the fixture device is rectangular shaped, wherein the z-mounting eyelet and the z-centering bolt interact positively locked in z-direction after alignment of the fixture device.
